(19) United States
(12) Patent Application Publication
(10) Pub. No.: US 2024/0121747 A1
(43) Pub. Date: Apr. 11, 2024

(54) Method and Device for Determining a Position of a Mobile Wireless Device in a Wireless Communication Network

(71) Applicant: Hong Kong Applied Science And Technology Research Institute Co., Ltd., Shatin (HK)

(72) Inventors: Zhen Chen, Tai PO (HK); Haiming Zhang, Tai Po (HK); Ho Yin Chan, Hung Hom (HK); Yuxian Zhang, Tai Po (HK)

(21) Appl. No.: 17/960,271

(22) Filed: Oct. 5, 2022

(51) Int. Cl. H04W 64/00

(52) U.S. Cl. CPC H04W 64/00

(57) ABSTRACT

Described is a method of determining a position of a mobile wireless device in a wireless communication network. The method comprises, for a plurality of clusters of transmission reception points (TRPs) associated with said mobile wireless device, measuring a parameter of first reference signals transmitted between said mobile wireless device and a single TRP from each cluster of TRPs. The method includes, based on the respective measured parameter of the first reference signals, selecting one cluster of TRPs from said plurality of clusters of TRPs. Position estimation information is determined from second reference signals transmitted between said mobile wireless device and a plurality of the TRPs comprising the selected cluster of TRPs. The determined position estimation information is used to determine a position for said mobile wireless device.

### FIELD OF THE INVENTION

The invention relates particularly, but not exclusively, to a method and a device for determining a position of a mobile wireless device in a wireless communication network and, more particularly, to a method and a device for reference signal-based positioning of mobile wireless devices in a Fifth Generation (5G) New Radio (NR) communication network.

### BACKGROUND OF THE INVENTION

The 3^{rd} Generation Partnership Project (3GPP) Release 16 concerns a Long-Term Evolution (LTE) positioning feature which is extended to accommodate enablers of 5G such as wideband signals, low latency and flexible architecture. The radio equipment in 5G NR networks need a more accurate positioning method to meet the NR positioning requirements for regulatory and commercial applications, for example.

Among existing NR reference signal-based positioning methods, there are two generic types of positioning methods, namely a time-based positioning method and an angle-based positioning method. The time-based positioning method includes Downlink Time Difference of Arrival (DL-TDOA), Uplink Time Difference of Arrival (UL-TDOA) and Multi-cell Round Trip Time (RTT). The angle-based positioning method includes Downlink Angle-of-Departure (DL-AOD) and Uplink Angle-of-Arrival (UL-AOA). These methods are designed to meet initial 5G positioning requirements.

In a reference signal-based positioning procedure, if all the Transmission Reception Points (TRPs) are included in the positioning calculation, it will lead to high computational complexity. Since measurement uncertainties are inevitable in any positioning procedure, there will be a position estimation error in the final position result. Therefore, it is desirable to reduce the computational complexity and/or the position estimation error resulting from measurement uncertainty which is critical for most positioning systems.

CN107367277B discloses an indoor position fingerprint positioning method based on two K-Means clustering operations. The fingerprint positioning method comprises: carrying out a first K-means clustering operation on the position fingerprint database to determine the clustering center; then carrying out a second K-means clustering operation on the position fingerprint database to determine the final clustering center. This method requires the building of a fingerprint database which requires collection of a considerable amount of measurement data depending on the resolution required. It also requires that a K-means algorithm must be run twice until all data points in the fingerprint database are divided.

CN107295636A relates to the TDOA location technology field, especially to a mobile station location device and method based on TDOA location. A location engine performs data processing of the mobile station, and a plurality of modes are employed to realize position location of the mobile station. All the location stations can perform synchronization processing; all the location stations broadcast location information; all the location stations receive location information broadcasted by other location stations and upload related time stamps and location information corresponding to the location station to the location engine in real time for storage; the location engine obtains a distance value or a distance difference related to the mobile station according to the fixed station position information and a related time stamp; and based on the distance value or the distance difference and the fixed station position coordinate information, a correlation positioning method is employed to obtain coordinates of the mobile station. This process requires acquisition of position data along with all of the TRP's time stamps which involves a high computational overhead in a practical positioning system. It establishes a positioning result by using at least three distance difference equations, but does not take into account the reliability of the result.

Among other things, what is therefore desired is an improved method of reference signal-based positioning of mobile wireless devices in a 5G NR communication network, preferably with reduced computational complexity.

Objects of the Invention.

An object of the invention is to mitigate or obviate to some degree one or more problems associated with known methods of determining a position of a mobile wireless device in a wireless communication network and, more particularly, to mitigate or obviate to some degree one or more problems associated with known methods of reference signal-based positioning of mobile wireless devices in 5G NR communication networks.

The above object is met by the combination of features of the main claims; the sub-claims disclose further advantageous embodiments of the invention.

Another object of the invention is to provide a node configured to implement an improved method of reference signal-based positioning of mobile wireless devices in a 5G NR communication network, preferably with reduced computational complexity, reduced measurement uncertainty, and/or reduced estimation error.

Another object of the invention is to provide a scheme to implement an improved method of reference signal-based positioning of mobile wireless devices in a 5G NR communication network, preferably with reduced position estimation error resulting from the measurement uncertainty. One skilled in the art will derive from the following description other objects of the invention. Therefore, the foregoing statements of object are not exhaustive and serve merely to illustrate some of the many objects of the present invention.

### SUMMARY OF THE INVENTION

In a first main aspect, the invention provides a method of determining a position of a mobile wireless device in a wireless communication network. The method comprises, for a plurality of clusters of transmission reception points (TRPs) associated with said mobile wireless device, measuring a parameter of first reference signals transmitted between said mobile wireless device and a single TRP from each cluster of TRPs. The method includes, based on the respective measured parameter of the first reference signals, selecting one cluster of TRPs from said plurality of clusters of TRPs. Position estimation information is determined from second reference signals transmitted between said mobile wireless device and a plurality of the TRPs comprising the selected cluster of TRPs. The determined position estimation information is used to determine a position for said mobile wireless device.

The proposed invention can reduce the complexity and/or the positioning estimation error by only considering results from TRPs with reliable measurements and can further improve the accuracy based on a scheme with favorable weight settings.

In a second main aspect, the invention provides a node in a wireless communication system comprising a memory storing machine-readable instructions and a processor for executing the machine-readable instructions such that, when the processor executes the machine-readable instructions, it configures the node to implement the steps of the first main aspect of the invention.

In a third main aspect, the invention provides a non-transitory computer-readable medium storing machine-readable instructions, wherein, when the machine-readable instructions are executed by a processor or a controller, they configure the processor or controller to implement the steps of the first main aspect of the invention.

The summary of the invention does not necessarily disclose all the features essential for defining the invention; the invention may reside in a sub-combination of the disclosed features.

The forgoing has outlined broadly the features of the present invention in order that the detailed description of the invention which follows may be better understood. Additional features and advantages of the invention will be described hereinafter which form the subject of the claims of the invention. It will be appreciated by those skilled in the art that the conception and specific embodiment disclosed may be readily utilized as a basis for modifying or designing other structures for carrying out the same purposes of the invention.

### BRIEF DESCRIPTION OF THE DRAWINGS

The foregoing and further features of the present invention will be apparent from the following description of preferred embodiments which are provided by way of example only in connection with the accompanying figures, of which:

FIG. 1 comprises a schematic diagram of a known 5G NR wireless network architecture supporting positioning;

FIG. 2 illustrates the known use of the Positioning Reference Signal (PRS) and/or the Sounding Reference Signal (SRS) to determine a position of a UE in a 5G NR wireless network;

FIG. 3 comprises a schematic diagram of a network environment comprising multiple TPRs in a 5G NR wireless network;

FIG. 4 comprises a schematic block diagram of a node comprising a Location Management Function (LMF) in a 5G NR wireless network;

FIG. 5 comprises a flowchart of the positioning method in accordance with the invention;

FIG. 6 illustrates a local region or area comprising a network environment comprising multiple TPRs in a 5G NR wireless network at initialization of the multiple TRPs;

FIG. 7 illustrates the network environment of FIG. 6 in which the multiple TPRs have been clustered;

FIG. 8 illustrates a method in the network environment of FIG. 7 for selecting one of the TPR clusters as a ‘trusted’ cluster;

FIG. 9 illustrates the network environment of FIG. 8 in which one of the TPR clusters has been selected as a ‘trusted’ cluster; and

FIG. 10 illustrates a method of using reference signal weighting values in combination with multiple positioning estimation results to enhance or improve a final position result for a UE.

### DESCRIPTION OF PREFERRED EMBODIMENTS

The following description is of preferred embodiments by way of example only and without limitation to the combination of features necessary for carrying the invention into effect.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments, but not other embodiments.

It should be understood that the elements shown in the FIGS, may be implemented in various forms of hardware, software or combinations thereof. These elements may be implemented in a combination of hardware and software on one or more appropriately programmed general-purpose devices, which may include a processor, memory and input/output interfaces.

The present description illustrates the principles of the present invention. It will thus be appreciated that those skilled in the art will be able to devise various arrangements that, although not explicitly described or shown herein, embody the principles of the invention and are included within its spirit and scope.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of systems and devices embodying the principles of the invention.

The functions of the various elements shown in the figures may be provided using dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. It is thus regarded that any means that can provide those functionalities are equivalent to those shown herein.

5G NR wireless networks are required to support massive connectivity, high capacity, ultra-reliability and low latency. Such diverse use case scenarios require disrupting approaches for the realization of such 5G NR wireless networks. It is envisioned that multiple TRPs (multi-TRPs) will be required in 5G NR wireless networks in order to improve reliability, coverage, and capacity performance through flexible deployment scenarios. For example, to be able to support the exponential growth in mobile data traffic in 5G NR wireless networks and to enhance coverage, the mobile wireless devices are expected to access networks composed of multi-TRPs (i.e., macro-cells, small cells, pico-cells, femto-cells, remote radio heads, relay nodes, etc.).

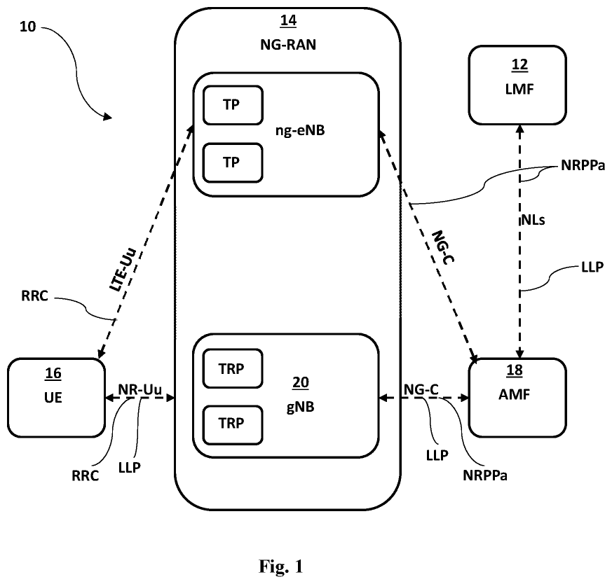

FIG. 1 comprises a schematic diagram of a known 5G NR wireless network architecture 10 supporting positioning. This is described by way of background only. A network entity comprising a location management function (LMF) 12 comprises a node in this known 5G NR wireless network positioning architecture 10. The LMF 12 receives measurements and assistance information from the next generation radio access network (NG-RAN) 14 and the mobile wireless device(s) 16, otherwise known as the user equipment(s) (UE) 16, via an access and mobility management function (AMF) 18 over an NLs interface to determine the position of the UE 16. Due to a new next generation interface between the NG-RAN 14 and the core network (not shown), a new NR positioning protocol A (NRPPa) protocol has been introduced to carry the positioning information between the NG-RAN 14 and the LMF 12 over the next generation control plane interface (NG-C). These additions in the 5G NR wireless architecture 10 provide a framework for positioning in 5G. The LMF 12 configures the UE 16 using the LTE positioning protocol (LPP) via the AMF 18. The NG RAN 14 configures the UE 16 using the radio resource control (RRC) protocol over the LTE-Uu interface or the NR-Uu interface. The Uu interfaces are the interfaces for UE communication with the base station to support uplink unicast communication from UE to the base station as well as downlink unicast communication from the base station to the UE. The NLs interface, between the LMF and the AMF, is transparent to all UE related, gNB related and ng-eNB related positioning procedures. It is used only as a transport link for the LTE Positioning Protocols LPP and NRPPa.

To enable more accurate positioning measurements than previously provided by LTE, new reference signals have been added to the 5G NR specifications. These signals are the positioning reference signal (NR PRS or PRS) in the downlink and the sounding reference signal (SRS) for positioning in the uplink. The downlink PRS is the main reference signal supporting downlink-based positioning methods. Although other signals can be used, PRS is specifically designed to deliver the highest possible levels of accuracy, coverage, and interference avoidance and suppression. To design an efficient PRS, special care is taken to give the signal a large delay spread range, since it must be received from potentially distant neighboring base stations for position estimation. This is achieved by covering the whole 5G NR bandwidth and transmitting PRS over multiple symbols that can be aggregated to accumulate power. The density of subcarriers in a given PRS symbol is referred to as the comb size. There are several configurable comb-based PRS patterns for comb-2,4,6 and 12 suitable for different scenarios serving different use cases. The comb pattern for several base stations may be multiplexed over one slot duration, for example. For comb-N PRS, N symbols can be combined to cover all the subcarriers in the frequency domain. Each base station (gNB 20) can then transmit in different sets of subcarriers to avoid interference. Since several gNBs 20 can transmit at the same time without interfering with each other, this solution is also latency efficient. Moreover, it is possible to mute the PRS from one or more gNBs 20 at a given time according to a muting pattern, further lowering the potential interference. For use cases with higher transmission loss (for example, in macro cell deployments) the PRS can be also configured to be repeated to improve reception.

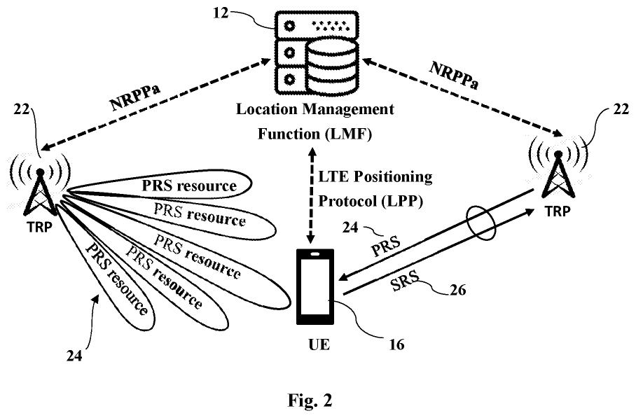

FIG. 2 illustrates the known use of the PRS and/or SRS to determine a position of a UE 16. The LMF 12 communicates with the TRPs 22 using the NRPPa protocol. The LMF 12 communicates with the UE 16 using the LLP protocol. The multiple PRSs 24 comprise a resource set of PRSs.

As illustrated in FIG. 2, the UE 16 receives at least one PRS 24 from one or more TRPs 22 and reports to the LMF 12 any or all of the following UE-based measurement reports for positioning for each received PRS: Downlink reference signal reference power (DL RSRP) per beam per gNB 20; Downlink reference signal time difference (DL RSTD); UE receiver-transmitted (RX-TX) time difference. The LMF 12 uses some or all of this information to determine or calculate a position for the UE 16. The position of the UE 16 can be determined or calculated as geographical coordinates.

Also as illustrated in FIG. 2, the UE 16 receives at least one PRS 24 or other DL reference signal (DL-DMRS) from one or more TRPs 22 and, in response, transmits a SRS 26 or other UL reference signal (UL-DMRS) for each received PRS to one or more TRPs 22. In response, each of the one or more TRP 22 reports to the LMF 12 any or all of the following gNB-based measurement reports for positioning for each received SRS: Uplink angle-of-arrival (UL-AoA); Uplink reference-signal receive power (UL-RSRP); UL relative time of arrival (UL-RTOA); gNB RX-TX time difference. The LMF 12 uses some or all of this information to determine or calculate a position for the UE 16.

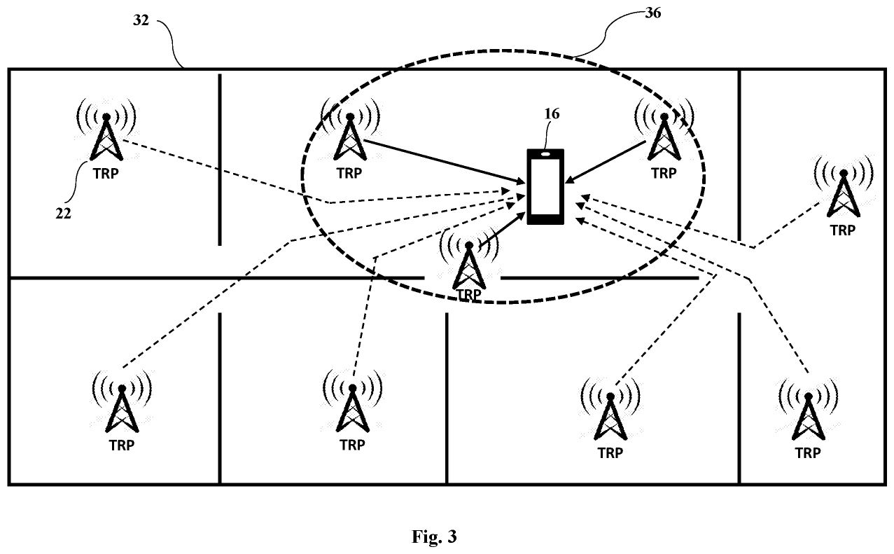

The foregoing methods can result in high computational complexity and high positioning error rate if all TRPs 22 associated with the UE 16 are included in the positioning determination or calculation. Furthermore, the high computational complexity and that some TRPs may have poor communication quality with the UE 16 can lead to an undesirable increase in an estimation error in the final position result. This is illustrated by way of example in FIG. 3 which shows multiple TRPs 22 arranged in an indoor environment 32. A UE 16 is associated with the multiple TRPs 22 in that the UE 16 receives signals from some or all of said TRPs 22 when the UE 16 is in the environment 32. In such an environment 32, some of the signals from some of the TRPs 22 reaching the UE 16 are strong, e.g., have good signal quality, but many of the signals from other TRPs 22 have poor signal quality. The high-quality signals are illustrated in FIG. 3 for ease of reference by full-lined arrows whereas the poor signal quality signals are illustrated by dashed-line arrows. If the UE-based measurement reports for positioning and/or the gNB-based measurement reports for positioning are included in the determination or calculation of the position of the UE 16 in the environment 32, this can lead to large errors in the resulting position. This is caused not least by sending measurement reports for positioning generated from many low-quality signals received by the UE 16. The dash-line zone 36 in FIG. 3 is indicative of TRPs 22 whose signals are received by the UE 16 with high signal quality. Typically, such TRPs 22 are those to which the UE 16 is closest in distance at an appropriate point in time. It will be understood, however, that, depending on the arrangement of the environment 32, it is not always the case that TRPs 22 to which the UE 16 is closest provide the best quality signals.

The example environment 32 in FIG. 3 is described as an indoor environment, but this should not be taken as limiting the use of the method of the invention as hereinafter described in only indoor environments.

The present invention recognizes that a reduction in computational complexity can be achieved by considering, using or involving TRPs 22 with reliable measurement data, i.e., TRPs 22 which provide good signal quality signals to the UE 16 and therefore not using all of the TRPs 22 associated with the UE 16. The present invention addresses at least the need to reduce the computational complexity and advantageously also leads to improved accuracy and shortened data processing time.

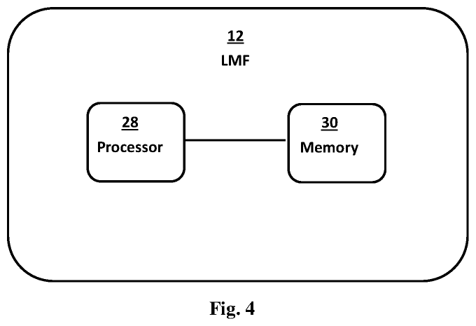

FIG. 4 illustrates that the LMF 12 comprises at least one processor 28 and at least one memory 30. The at least one memory 30 stores machine-readable instructions. The at least one processor 28 executes the machine-readable instructions such that it configures the LMF 12 to implement the steps of the method in accordance with the invention as hereinafter described.

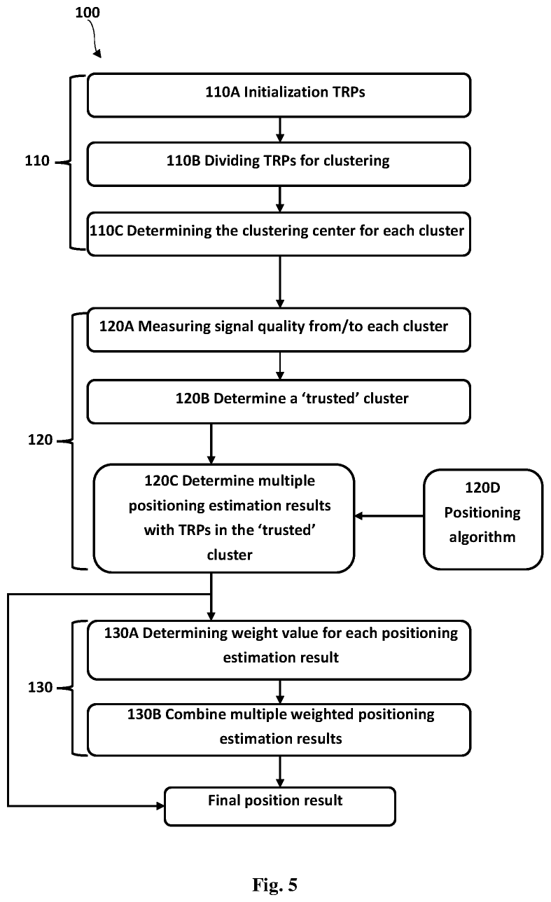

FIG. 5 comprises a flowchart of the method 100 in accordance with the invention. The method comprises three main parts: a first part 110 which relates to arranging the TRPs 22 into respective clusters; a second part 120 which relates to using only a selected one of the TRP clusters to determine which cluster's TRPs would be used in positioning and to calculate the position of the UE 16; and a third part 130 which relates to further improving the accuracy of a position result obtained from the second part 120.

The first part 110 of the method 100 is advantageously able to be implemented offline. The second part 120 and the third part 130 of the invention are implemented online, i.e., in real-time. It will be understood that, for an established environment 32, the first part 110 of the method 100 may only need to be implemented once, although the first part 110 can be implemented again offline or online should there be any changes made to the network environment 32. The third part 130 of the method 100 is preferably implemented, but it will be understood that can be an optional part of the method 100 for some embodiments.

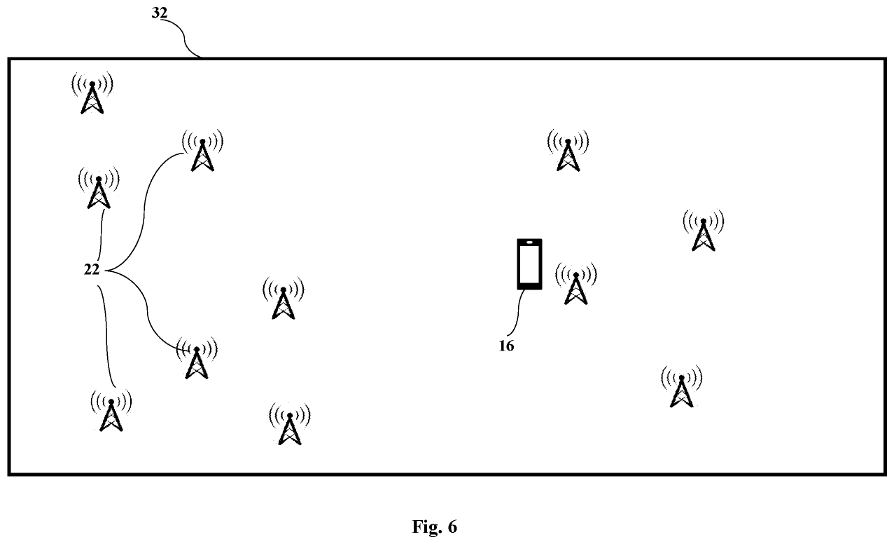

FIG. 6 illustrates a local region or area comprising the environment 32 at initialization of the multiple TRPs 22 and therefore in a state prior to arranging the TRPs 22 into respective clusters using a clustering algorithm such as the K-means clustering algorithm to identify or select a subset of the TRPs 22 having reliable measurements. The TRPs 22 are capable of communicating with any UE 16 which enters the environment 32. A UE 16 is illustrated for reference.

The first part 110 of the method 100 of the invention comprises, as a first step 110A, initializing the TRPs 22 although this step is optional in that the TRPs 22 may already have been previously initialized.

In a next step 110B of the first main part 110 of method 100, the TRPs 22 are divided and clustered using a clustering algorithm. Any suitable clustering algorithm may be utilized, but the K-means clustering algorithm is preferred.

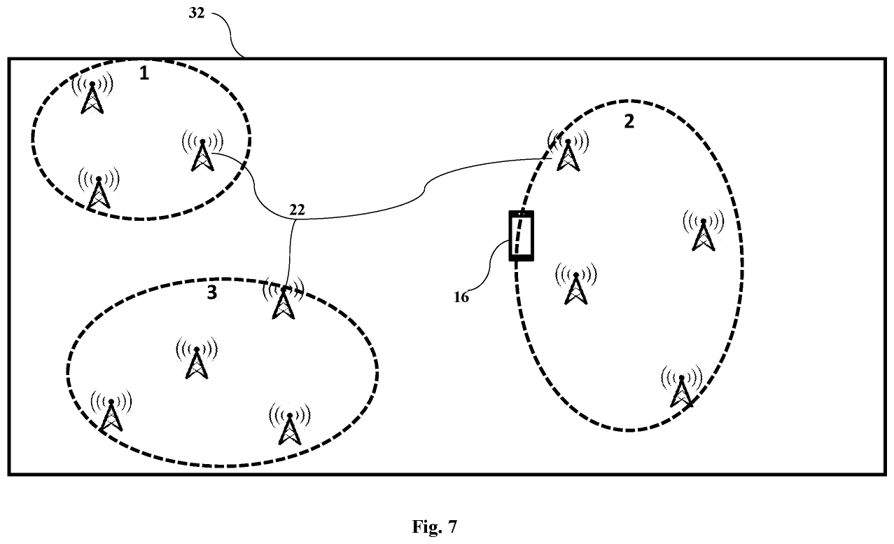

Step 110B may comprise determining or selecting a number K of TRP clustering centers in the environment 32 where each TRP clustering center will corresponds to one cluster of TRPs 22 and where K≥2. The number K may be pre-defined or may be calculated based on the number of TRPs 22 and the size of the environment 32 and/or the signal quality of the TRPs 22. Step 110B includes determining distances and/or signal quality between each TRP 22 and each of the K TRP clustering centers. The TRPs 22 are then divided or arranged into respective TRP clusters corresponding to said K TRP clustering centers. This may be done by arranging each TRP 22 into the TRP cluster having a TRP clustering center which the TRP 22 is at a minimum distance from and/or has the largest measured signal strength. The respective TRP clusters are denoted respectively as “1”, “2”, and “3” in FIG. 7 where K is selected as having the value K=3.

In a next step 110C of the first main part 110 of method 100, the method preferably comprises determining or calculating new TRP clustering centers. This may be achieved by calculating a mean distance value of each cluster of TRPs and selecting the TRP 22 having a distance to the corresponding TRP clustering center that is closest to the mean value and treating the position of the selected TRP 22 as a new TRP clustering center or randomly selecting one of the TRPs 22 in the cluster as the new TRP clustering center as all TRPs 22 in a cluster should have the same level of signal quality with each other.

The first main part 110 of the method 100 may include repeating steps 110A and 110B until the K clustering centers remain unchanged, these then comprising the final clustering centers and thus the final clusters “1”, “2”, and “3” as shown in FIG. 7.

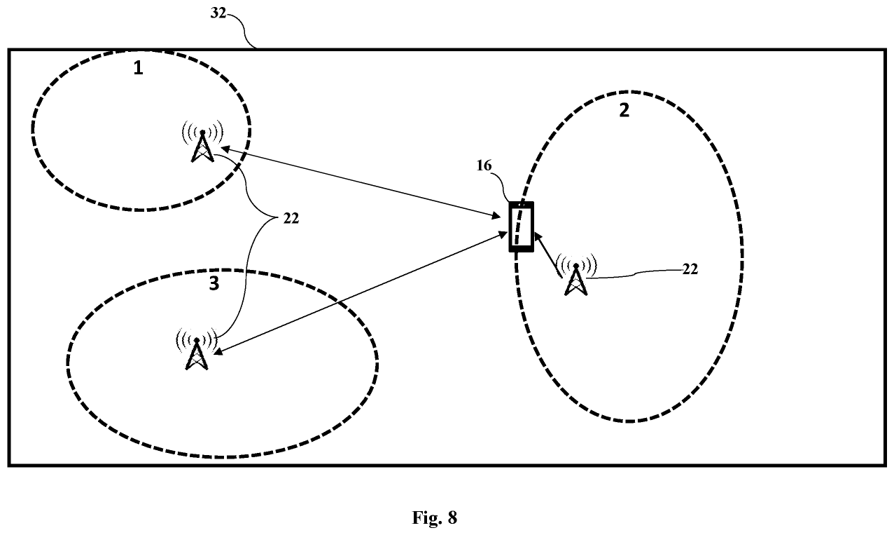

Referring to FIG. 8, the second part 120 of the method 100 comprises a first step 120A of measuring a parameter of a first reference signal transmitted between the UE 16 and a single TRP 22 from each TRP cluster “1”, “2”, and “3”. The first reference signal may be received at the UE 16, but in some embodiments, the first reference signal for each of the selected single TRPs 22 may be received at the TRPs. The first reference signal may comprise a PRS or an SRS. The single TRP 22 determined or selected from each TRP cluster may comprise the respective TRP cluster's clustering center TRP or it may comprise another TRP 22 selected from the TRP cluster. It may, for example, comprise a TRP 22 located centrally of its respective cluster “1”, “2”, and “3”. In any event, the respective measured parameter of the first reference signals may comprise a signal quality parameter. The signal quality parameter may comprise any of: signal-to-noise ratio (SNR); received signal strength indicator (RSSI); reference signal received power (RSRP); and reference signal received quality (RSRQ) or any other suitable signal quality parameter.

In a next step 120B of the the second part 120 of the method 100, the method involves determining or selecting one TRP cluster from the plurality of TRP clusters “1”, “2”, and “3” as a ‘trusted’ TRP cluster. The determination or selection of the ‘trusted’ TRP cluster is preferably based on the respective measured parameter of the first reference signals and preferably such that the ‘trusted’ TRP cluster is selected as the TRP cluster “1”, “2”, and “3” having a highest, best, maximum, or optimal value of the measured signal quality parameter. In the example of FIG. 8, the TRP cluster denoted as “2” is selected as the ‘trusted’ TRP cluster.

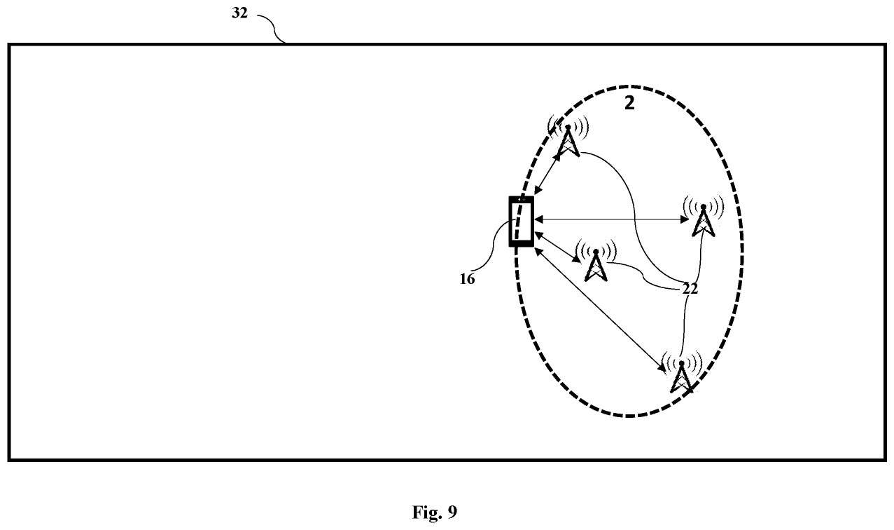

Referring to FIG. 9, in a next step 120C of the the second part 120 of the method 100, the method involves determining position estimation information comprising multiple positioning estimation results from the second reference signals transmitted between said UE 16 and some, but preferably all, of the TRPs 22 comprising the ‘trusted’ TRP cluster “2”. This reduces computational complexity and shortens data processing time in the positioning method. TRP cluster “1” and “3” are not shown in FIG. 9. The determined multiple positioning estimation results derived from the second reference signals are combined and used to determine the position for the UE 16. Preferably, the multiple positioning estimation results determined from the second reference signals are determined using a time-based positioning algorithm 120D (FIG. 5). This may comprise a multi-TRP or TDOA algorithm. The multiple positioning estimation results are determined or calculated using the timing measurements results from preferably all TRPs 22 in the ‘trusted’ TRP cluster “2”. The timing measurement results preferably comprise the first arriving path from or to each TRP 22 in the ‘trusted’ TRP cluster “2”.

The multiple positioning estimation results may be obtained from single TRPs 22 comprising the ‘trusted’ TRP cluster “2”, but are preferably obtained from subsets of said TRPs 22. In one embodiment, subsets of 3 TRPs 22 from the ‘trusted’ TRP cluster “2” are used to obtain respective ones of the multiple positioning estimation results. The multiple positioning estimation results are combined to obtain a final position result for the UE 16.

In one embodiment, where the second reference signals comprise PRSs, the multiple positioning estimation results may be derived from any or all of the following UE-based measurement reports for positioning: Downlink PRS reference signal reference power (DL PRS-RSRP) per beam per gNB 20; Downlink reference signal time difference (DL RSTD); UE receiver-transmitted (RX-TX) time difference. The LMF 12 uses some or all of this information to determine or calculate a position for the UE 16. The position of the UE 16 can be determined or calculated as geographical coordinates.

In another embodiment, the UE 16 receives PRSs from some, but preferably all of the TRPs 22 of the one or more TRPs 22 of the ‘trusted’ TRP cluster “2” and transmits SRSs to one of the TRPs 22 located at a gNB. The TRP 22 reports to the LMF 12 any or all of the following gNB-based measurement reports for positioning for each received SRS: Uplink angle-of-arrival (UL-AoA); Uplink SRS reference-signal receive power (UL SRS-RSRP); UL relative time of arrival (UL-RTOA); gNB RX-TX time difference. The LMF 12 uses some or all of this information to determine or calculate multiple positioning estimation results for the UE 16 and from these results to determine a position for the UE 16. The position of the UE 16 can be determined or calculated as geographical coordinates.

The third optional part 130 of the method 100 makes use of weighting values in combination with the multiple positioning estimation results. However, whilst the use of weighting values is much preferred and reduces unpredictable risks in the positioning result which may result from low received signal quality signals, it will be understood that the use of weighting values is preferable to the implementation of method 100.

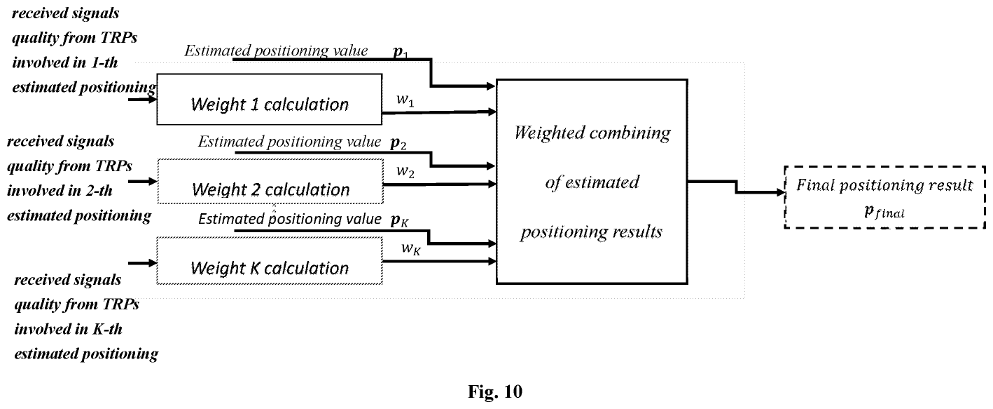

Referring to FIG. 10, the third optional part 130 of the method 100 comprises a first step 130A of measuring a parameter of the second reference signals transmitted between the UE 16 and the TRPs 22 of the ‘trusted’ TRP cluster “2”. The respective measured parameter of the second reference signals preferably comprises a signal quality parameter and the respective weight values are calculated based on the respective measured signal quality of the second reference signals. The respective weight values are calculated to enhance the multiple positioning estimation results for any second reference signals having a high value of the measured signal quality parameter and to diminish the multiple positioning estimation results for any second reference signals having a low value of the measured signal quality parameter.

The third optional part 130 of the method 100 includes a second step 130B of combining respective weight values calculated from the respective values of the measured parameter of the second reference signals with the respective multiple positioning estimation results to provide respective weighted position estimation results. The respective weighted position estimation results are then used to determine an enhanced position for the UE 16. The weighted position estimation results are preferably normalized prior to being used to determine the position of the UE 16.

In the example of FIG. 10, a first estimated position value p₁ for the UE 16 is derived from the second reference signals transmitted between the UE 16 and a first subset of the TRPs 22 of the ‘trusted’ TRP cluster “2”. A second estimated position value p₂ for the UE 16 is derived from the second reference signals transmitted between the UE 16 and a second subset of the TRPs 22 and so on until a final K-th estimated position value p_{K} for the UE 16 is derived from a K-th subset of TRPs 22. For each of the first to K-th subsets of TRPs 22, respective weight values w₁ to w_{K} are determined or calculated based on the signal quality of the second reference signals for each of the first to K-th subsets of the TRPs 22. The respective weight values w₁ to w_{K} are combined with the estimated positioning values p₁ to p_{K} to provide a final positioning result p_{final}=Σᵢ₌₁^{K} wᵢpᵢ.

In one embodiment, for any three TRPs 22 of the ‘trusted’ TRP cluster “2”, the positioning estimation results pᵢ (i, =1, 2, . . . , K=3) can be obtained by using the TDOA positioning algorithm. Then, for each or any three TRPs 22, the quality of the three respective reference signals can be measured (e.g., RSSI), which can then be used to generate a weight function ƒ(RSSIᵢ₁, RSSIᵢ₂, RSSIᵢ₃). The weight function is then normalized to obtain normalized weight values and the multiple positioning estimations results are combined to provide the final positioning result p_{ƒinal}=Σᵢ₌₁^{K}wᵢpᵢ. In this embodiment, the weight function can be expressed as:

$$\\ f ( {RSSI}_{i 1} , {RSSI}_{i 2} , {RSSI}_{i 3} ) = \frac{{RSSI}_{i 1} + {RSSI}_{i 2} + {RSSI}_{i 3}}{3} .$$

Where K=3, w₁ has values of i=1,2,3. Consequently, the values for the normalization of the weight function can be obtained from:

w₁=w₁/(w₁+w₂+w₃);

w₂=w₂/(w₁+w₂+w₃); and

w₃=w₃/w₁+w₂+w₃).

Therefore p_{ƒinal}=Σᵢ₌₁^{K}wᵢpᵢ=w₁p₁+w₂p₂+w₃p₃ p₁=(x₁, y₁, z₁), p₂=(x₂, y₂, z₂) and p₃=(x₃, y₃, z₃).

In the method 100 of the invention, a time-based 2D positioning algorithm, comprises TDOA or RTT.

For a 2-D coordinate system: TDOA (at i-th estimated positioning results):

$$\\ ( {T}_{i 1} - {T}_{i 3} ) = \frac{\sqrt{{( {p}_{x , i} - {p}_{x , i 1} )}^{2} + {( {p}_{y , i} - {p}_{y , i 1} )}^{2}}}{c} - \frac{\sqrt{{( {p}_{x , i} - {p}_{x , i 3} )}^{2} + {( {p}_{y , i} - {p}_{y , i 3} )}^{2}}}{c} ,$$

$$\\ ( {T}_{i 2} - {T}_{i 3} ) = \frac{\sqrt{{( {p}_{x , i} - {p}_{x , i 2} )}^{2} + {( {p}_{y , i} - {p}_{y , i 2} )}^{2}}}{c} - \frac{\sqrt{{( {p}_{x , i} - {p}_{x , i 3} )}^{2} + {( {p}_{y , i} - {p}_{y , i 3} )}^{2}}}{c}$$

where pᵢ=(p_{x,i}, p_{y,i})^{T} is the coordinate location of user to be estimated, pᵢ₁=(p_{x,i1}, p_{y,i1})^{T}, pᵢ₂=(p_{x,i2}, p_{y,i2})^{T}, pᵢ₃=(p_{x,i3}, p_{y, i3})^{T} are the coordinate location of TRPᵢ₁, TRPᵢ₂ and TRPᵢ₃, respectively; Tᵢ₁, Tᵢ₂ and Tᵢ₃ are the timing measurement results of TRPᵢ₁, TRPᵢ₂ and TRPᵢ₃, respectively; c is the speed of light.

For the 2-D coordinate system: RTT (at i-th estimated positioning results)

$$\\ {RTT}_{i 1} = 2 ( \frac{\sqrt{{( {p}_{x , i} - {p}_{x , i 1} )}^{2} + {( {p}_{y , i} - {p}_{y , i 1} )}^{2}}}{c} )$$

$$\\ {RTT}_{i 2} = 2 ( \frac{\sqrt{{( {p}_{x , i} - {p}_{x , i 2} )}^{2} + {( {p}_{y , i} - {p}_{y , i 2} )}^{2}}}{c} )$$

$$\\ {RTT}_{i 3} = 2 ( \frac{\sqrt{{( {p}_{x , i} - {p}_{x , i 3} )}^{2} + {( {p}_{y , i} - {p}_{y , i 3} )}^{2}}}{c} )$$

where RTTᵢ₁, RTTᵢ₂, and RTTᵢ₃ are the round-trip time from user to TRPᵢ₁, TRPᵢ₂ and TRPᵢ₃, respectively; pᵢ=(p_{x,i}, p_{y,i}) T is the coordinate location of user to be estimated, pᵢ₁=(p_{x,i1}, p_{y,i1})^{T}, pᵢ₂=(p_{x,i2}, p_{y,i2})^{T}, pᵢ₃=p_{x,i3}, p_{y,i3})^{T} are the coordinate location of TRPᵢ₁, TRPᵢ₂ and TRPᵢ₃, respectively; and c is the speed of light.

In the method 100 of the invention, a time-based 3D positioning algorithm comprises RTT. Therefore, for a 3-D coordinate system: RTT (at i-th estimated positioning results)

$$\\ {RTT}_{i 1} = 2 ( \frac{\sqrt{{( {p}_{x , i} - {p}_{x , i 1} )}^{2} + {( {p}_{y , i} - {p}_{y , i 1} )}^{2} + {( {p}_{z , i} - {p}_{z , i 1} )}^{2}}}{c} )$$

$$\\ {RTT}_{i 2} = 2 ( \frac{\sqrt{{( {p}_{x , i} - {p}_{x , i 2} )}^{2} + {( {p}_{y , i} - {p}_{y , i 2} )}^{2} + {( {p}_{z , i} - {p}_{z , i 2} )}^{2}}}{c} )$$

$$\\ {RTT}_{i 3} = 2 ( \frac{\sqrt{{( {p}_{x , i} - {p}_{x , i 3} )}^{2} + {( {p}_{y , i} - {p}_{y , i 3} )}^{2} + {( {p}_{z , i} - {p}_{z , i 3} )}^{2}}}{c} )$$

where RTTᵢ₁, RTTᵢ₂, and RTTᵢ₃ are the round-trip time from the UE 16 to TRPᵢ₁, TRPᵢ₂ and TRPᵢ₃, respectively; pᵢ=(p_{x,i}, p_{y,i}, p_{z,i})^{T} is the coordinate location of user to be estimated; pᵢ₁=(p_{x,i1}, p_{y,i1}, p_{z,i1})^{T}, pᵢ₂=(p_{x,i2}, p_{y,i2}, p_{z,i2})^{T}, pᵢ₃=(p_{x,i3}, p_{y,i3}, p_{z,i3})^{T} are the coordinate location of TRPᵢ₁, TRPᵢ₂ and TRPᵢ₃, respectively; and c is the speed of light.

The apparatus described above may be implemented at least in part in software. Those skilled in the art will appreciate that the apparatus described above may be implemented at least in part using general purpose computer equipment or using bespoke equipment.

Here, aspects of the methods and apparatuses described herein can be executed on any apparatus comprising the communication system. Program aspects of the technology can be thought of as “products” or “articles of manufacture” typically in the form of executable code and/or associated data that is carried on or embodied in a type of machine-readable medium. “Storage” type media include any or all the memory of the mobile stations, computers, processors or the like, or associated modules thereof, such as various semiconductor memories, tape drives, disk drives, and the like, which may provide storage at any time for the software pro-gramming. All or portions of the software may at times be communicated through the Internet or various other telecommunications networks. Such communications, for example, may enable loading of the software from one computer or processor into another computer or processor. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible non-transitory “storage” media, terms such as computer or machine “readable medium” refer to any medium that partic-ipates in providing instructions to a processor for execution.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limita-tions should be imposed as are indicated by the appended claims.

In the claims which follow and in the preceding description of the invention, except where the context requires otherwise due to express language or necessary implication, the word “comprise” or variations such as “comprises” or “comprising” is used in an inclusive sense, i.e., to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art.

1. A method of determining a position of a mobile wireless device in a wireless communication network, the method comprising the steps of:
for a plurality of clusters of transmission reception points (TRPs) associated with said mobile wireless device, measuring a parameter of first reference signals transmitted between said mobile wireless device and a single TRP from each cluster of TRPs;
based on the respective measured parameter of the first reference signals, selecting one cluster of TRPs from said plurality of clusters of TRPs;
determining position estimation information from second reference signals transmitted between said mobile wireless device and a plurality of the TRPs comprising the selected cluster of TRPs; and
using the determined position estimation information to determine a position for said mobile wireless device.

2. The method of claim 1, wherein the single TRP from each cluster of TRPs comprises a selected or predetermined single TRP from each cluster of TRPs.

3. The method of claim 2, wherein the selected or predetermined single TRP from each cluster of TRPs comprises a TRP located centrally of its respective cluster.

4. The method of claim 1, wherein the position estimation information determined from the second reference signals is determined using a time-based positioning algorithm or other positioning algorithm.

5. The method of claim 1, wherein the respective measured parameter of the first reference signals comprises a signal quality parameter and the selected cluster of TRPs from said plurality of clusters of TRPs is selected as the cluster of TRPs having a highest, best, maximum, or optimal value of the signal quality parameter.

6. The method of claim 5, wherein the signal quality parameter comprises any of: signal-to-noise ratio (SNR); received signal strength indicator (RSSI); reference signal received power (RSRP); and reference signal received quality (RSRQ).

7. The method of claim 1, wherein the position estimation information is determined from the second reference signals transmitted between said mobile wireless device and all of the TRPs comprising the selected cluster of TRPs.

8. The method of claim 1, wherein the method comprises:
measuring a parameter of the second reference signals transmitted between said mobile wireless device and the plurality of the TRPs comprising the selected cluster of TRPs;
combining respective weight values calculated from the respective values of the measured parameter of the second reference signals with the respective position estimation information determined from the second reference signals to provide respective weighted position estimation information; and
using the respective weighted position estimation information for the second reference signals to determine the position for said mobile wireless device.

9. The method of claim 8, wherein the respective measured parameter of the second reference signals comprises a signal quality parameter and the respective weight values are calculated based on the respective measured signal quality of the second reference signals.

10. The method of claim 9, wherein the respective weight values are calculated to enhance the position estimation information for any second reference signals having a high value of the measured signal quality parameter and to diminish the position estimation information for any second reference signals having a low value of the measured signal quality parameter.

11. The method of claim 8, wherein the weight values calculated from the respective values of the measured parameter of the second reference signals are normalized prior to combining said normalized weight values with the respective position estimation information and using the respective weighted position estimation information to determine the position for said mobile wireless device.

12. The method of claim 1, wherein the step of determining position estimation information from second reference signals transmitted between said mobile wireless device and the plurality of the TRPs comprising the selected cluster of TRPs comprises: using second reference signals comprising positioning reference signals (PRSs) or other DL reference signals (DL-DMRSs); or using second reference signals comprising sounding reference signals (SRSs) or other UL reference signals (UL-DMRSs); or using sounding reference signals (SRSs) transmitted by said mobile wireless device to a node in response to receiving the second reference signals comprising positioning reference signals (PRSs).

13. The method of claim 1, wherein the TRPs associated with said mobile wireless device are arranged into clusters using a clustering algorithm.

14. The method of claim 13, wherein the clustering algorithm comprises a K-means clustering algorithm.

15. The method of claim 13, wherein the step of arranging the TRPs associated with said mobile wireless device into clusters is performed offline.

16. The method of claim 1, wherein the TRPs are divided into clusters by:
(a) determining or selecting a number K of TRP clustering centers in a local region or area where each TRP clustering center corresponds to one cluster of TRPs and where K≥2;
(b) determining distances between each TRP and each of the K TRP clustering centers; and
(c) dividing the TRPs into respective clusters of TRPs corresponding to said K TRP clustering centers by dividing each TRP into the TRP clustering center which it is at a minimum distance from.

17. The method of claim 16, comprising the steps of:
(d) calculating a mean distance value of each cluster of TRPs and selecting the TRP having a distance to the corresponding TRP clustering center that is closest to the mean value as a new TRP clustering center.

18. The method of claim 17, wherein steps (b), (c) and (d) are repeated until the K clusters become unchanged, these being taken as the final clustering centers and clusters.

19. The method of claim 1, wherein the TRPs are divided into clusters by:
(a) determining or selecting a number K of TRP clustering centers in a local region or area where each TRP clustering center corresponds to one cluster of TRPs and where K≥2;
(b) measuring signal quality between each TRP and each of the K TRP clustering centers; and
(c) dividing the TRPs into respective clusters of TRPs corresponding to said K TRP clustering centers by dividing each TRP into a respective TRP clustering center based on the measured signal quality.

20. A node in a wireless communication system comprising a memory storing machine-readable instructions and a processor for executing the machine-readable instructions such that, when the processor executes the machine-readable instructions, it configures the node to implement the steps of:
for a plurality of clusters of transmission reception points (TRPs) associated with said mobile wireless device, measuring a parameter of first reference signals transmitted between said mobile wireless device and a single TRP from each cluster of TRPs;
based on the respective measured parameter of the first reference signals, selecting one cluster of TRPs from said plurality of clusters of TRPs;
determining position estimation information from second reference signals transmitted between said mobile wireless device and a plurality of the TRPs comprising the selected cluster of TRPs;
using the determined position estimation information to determine a position for said mobile wireless device.
